(19) United States
(12) Patent Application Publication
(10) Pub. No.: US 2019/0337061 A1
(43) Pub. Date: Nov. 7, 2019

(54) Dental Machining Unit Comprising A Milling Chamber

(71) Applicants: Martin Huber, Pfarrwerfen (AT); Alfons Wörmer, Bischofshofen (AT)

(72) Inventors: Martin Huber, Pfarrwerfen (AT); Alfons Wörmer, Bischofshofen (AT); Wolfgang Beck, St. Pantaleon (AT)

(21) Appl. No.: 16/474,691

(22) PCT Filed: Jan. 10, 2018
(86) PCT No.: PCT/EP2018/050505

§ 371 Date: Jun. 28, 2019

(30) Foreign Application Priority Data
Jan. 10, 2017 (EP) 17150787.4

(51) Int. Cl. B23C 3/16; B23Q 11/08; B23Q 1/62

(52) U.S. Cl. CPC B23C 3/16; A61C 13/12; B23Q 1/621; B23Q 11/0891

(57) ABSTRACT

The invention relates to a dental machining unit (1) having a milling chamber (10), wherein the workpiece arm (22) passes through a movement flange (24) at which the workpiece arm (22) passes through a passage wall (25) of the milling chamber (10), and that the passage wall (25) comprises a membrane (26) which permits movement of the workpiece arm (22) in at least two spatial directions and consists of a highly elastic material and particularly comprises corrugations (28).

### FIELD OF THE INVENTION

The invention relates to a dental machining unit comprising a milling chamber.

### BACKGROUND

Known machine tools for machining workpieces usually comprise too large dimensions with regard to the requirements of the dental field. Compact dimensions are particularly advantageous in the dental field with regard to dental machining units. Further, spatial movability of a machining tool which is as great as possible and a sealing of a machining chamber with respect to an environment with simultaneous accessibility of the machining chamber, for instance for changing a tool or a workpiece, are required.

DE 197 32 608 B4 discloses a machine tool for machining a workpiece which is clamped directly or indirectly onto a workpiece carrier which is guided slidably on a machine bed and which is surrounded by a machining chamber which delimits a work area, from which chips may be removed by means of a chip removal device, wherein guides of the workpiece carrier are arranged outside of the machining chamber.

### SUMMARY

Thus, the invention is based on the task of providing an improved dental machining unit comprising a milling chamber, which enables better sealing of the milling chamber with respect to an environment while at the same time improving the movability of a machining tool and the accessibility of the milling chamber.

The task is solved by means of a dental machining unit comprising the features of patent claim 1. Advantageous developments may be taken from the subclaims.

The present invention provides a dental machining unit comprising a milling chamber which comprises at least one sealed door and which is sealed with respect to the environment against leakage of liquid, wherein the milling chamber comprises a liquid feed line, in particular a nozzle, and a liquid outlet, and wherein by means of the liquid feed line, in particular the nozzle, a liquid may be fed to a work area of the dental machining unit in which a milling tool machines a workpiece, and wherein the workpiece is movably mounted to a workpiece arm in at least two spatial directions, characterized in that the workpiece arm passes through a movement flange at which the workpiece arm passes through a flat passage wall of the milling chamber, and in that the passage wall comprises a membrane which permits movement of the workpiece arm in at least two spatial directions and consists of a highly elastic material and particularly comprises corrugations.

It is an idea of the present invention to enable improved sealing of the milling chamber with respect to the environment of the dental machining unit and a good spatial positioning capability of the workpiece arm in the milling chamber by providing the membrane in the passage wall of the milling chamber.

According to a preferred development it is provided that the corrugations are configured as concentric circles or as concentric partial circles which substantially form sinusoidal curves when viewed in the cross section. In this way, good movability of the workpiece arm in all three spatial axes relative to the membrane is possible advantageously. The partial circles are configured on the side of the movement flange at which the membrane may be stretched particularly when the workpiece arm is moved such that particularly large material reserves are available thereat.

According to a further preferred development it is provided that at least two and at most twenty corrugations of the membrane extend radially towards the outside when viewed from the direction of the movement flange. Thus, the corrugations of the membrane may be adapted to a respective size of the milling chamber or to a requirement with regard to the movability or deflectability of the workpiece arm.

Preferably, the milling chamber comprises a flat rear wall which forms the passage wall. Instead, a side wall, the bottom wall or the ceiling wall may also be the passage wall.

According to a further preferred development it is provided that the membrane is held clamped in a sealed manner at the passage wall of the milling chamber by a connection flange which is configured to be circumferential. Thus, the membrane may advantageously fulfill its sealing function and does not need to fulfill any specific requirements with regard to mountability or tensile strength in edge regions as the connection flange is adjusted to these requirements. Preferably, the membrane is injection molded to or into the connection flange or vulcanized thereon. The edge of the membrane thereat may also be configured as a sealing lip to seal against the adjacent walls of the milling chamber.

According to a further preferred development it is provided that the movement flange of the workpiece arm is configured at a rigid partial arm of the workpiece arm which passes through the membrane. Thus, a good positioning capability of the workpiece arm relative to the membrane can be ensured advantageously.

According to a further preferred development it is provided that, beyond the flat passage wall, that is to say outside of the milling chamber, the workpiece arm comprises movement elements in three spatial directions corresponding to the x-, y-, z-axes and two rotational axes for rotating a tool chuck or a collet for the workpiece, possibly together with the workpiece clamped therein. Thus, the movement elements advantageously enable movement of the workpiece arm in the above-mentioned five axes.

According to a further preferred development it is provided that a milling spindle is provided in the milling chamber, wherein said milling spindle is arranged fixed in place and carries a tool chuck which carries a milling tool in a clamped manner in a way known per se, wherein said milling spindle is attached in particular to the bottom wall of the milling chamber. Due to the attachment of the milling spindle to the bottom wall of the milling chamber the milling tool may be positioned exactly relative to the milling spindle in the milling chamber in order to enable the desired removal of material from the workpiece.

According to a further preferred development it is provided that the liquid feed line is a nozzle, which is arranged substantially parallel or inclined to the extension of the membrane in the outflow direction. Thus, liquid flowing out of the nozzle cannot impinge on the membrane directly, in an advantageous manner. In this way, an improved tightness of the milling chamber may be enabled.

According to a further preferred development it is provided that the liquid feed line comprises several nozzles, whose outflow directions are substantially parallel, and that the liquid is fed to the machining area and thereat impinges on the milling tool and/or the workpiece during the machining process, before the liquid can reach the membrane. Thus, the liquid is preferably fed to the machining area or the milling tool and reaches the membrane only indirectly.

According to a further preferred development it is provided that a milling spindle is provided which carries a chuck for a milling tool, wherein the chuck carries at least one nozzle for the liquid feed line into the milling chamber, said nozzle rotating with the chuck. Thus, integrating the nozzle into the chuck advantageously enables a very compact design of the liquid feed line and at the same time a precise flow towards the tool.

According to a further preferred development it is provided that several nozzles are arranged at the chuck such that they are evenly distributed around the milling tool, whose outflow directions extend substantially parallel to the milling tool or are directed towards the tip of the milling tool. Thus, a steady flow of liquid towards the milling tool may be enabled.

According to a further preferred development it is provided that the sealed door is arranged at a wall surface of the milling chamber, preferably at a ceiling wall of the milling chamber, wherein the sealed door is configured such that by means of a tool changing magazine which is arranged beyond the wall surface of the milling chamber, that is to say outside of the milling chamber, a change of the milling tool may be performed when the door is open. Thus, the tool changing magazine may be arranged advantageously outside of the milling chamber of the dental machining unit.

According to a further preferred development it is provided that the sealed door comprises a plate-shaped element which is arranged at the wall surface of the milling chamber, preferably at the ceiling wall of the milling chamber, wherein the plate-shaped element covers an opening configured in the wall surface of the milling chamber, preferably in the ceiling wall of the milling chamber, when the door is closed, wherein the opening and/or the door comprises at least one sealing element. Thus, a door or cover with a simple construction may be provided advantageously which additionally enables good sealing of the milling chamber with respect to an environment.

According to a further preferred development it is provided that the door may be controlled such that the door may be carried along and opened by the movement of the workpiece arm and may be closed after the change of the milling tool has been carried out. For this purpose, the workpiece arm comprises a driver, for instance in the form of a pin which extends away laterally and acts against a recess or a driver edge of the door.

Thus, in an advantageous manner, the door is only opened if necessary. Preferably, the door is opened and closed automatically without the assistance of a user of the dental machining unit, thereby reducing the effort when changing the milling tool.

According to a further preferred development it is provided that the membrane is configured at least sectionally in the shape of a partial circle, wherein the membrane comprises a first portion configured in the shape of a partial circle, a second portion which is configured substantially linearly and which is adjacent to a first axial end portion of the first portion of the membrane configured in the shape of a partial circle, and a third portion which is configured substantially linearly and which is adjacent to a second axial end portion of the first portion of the membrane configured in the shape of a partial circle.

The described configurations and developments may be combined with one another at will.

Further possible configurations, developments and implementations of the invention also comprise not explicitly mentioned combinations of features of the invention which have been described before or will be described below with regard to the exemplary embodiments.

### BRIEF DESCRIPTION OF THE DRAWINGS

The attached drawings are to provide better understanding of the embodiments of the invention. They illustrate embodiments and serve to explain the principles and concepts of the invention in connection with the description.

Other embodiments and many of the advantages mentioned emerge with respect to the drawings. The illustrated elements of the drawings are not necessarily shown true to scale to one another.

FIG. 1 shows a schematic illustration of a dental machining unit according to a preferred embodiment of the invention;

FIG. 1 a shows a schematic sectional view of the clamping of the inventive membrane at the connection flange;

FIG. 2 shows a further schematic illustration of the dental machining unit according to the preferred embodiment of the invention;

FIG. 3 shows a cross-sectional view of a milling chamber of the dental machining unit according to the preferred embodiment of the invention;

FIG. 4 shows an enlarged illustration of a ceiling wall of the milling chamber of the dental machining unit when the door is closed according to the preferred embodiment of the invention; and

FIG. 5 shows an enlarged illustration of the ceiling wall of the milling chamber of the dental machining unit when the door is open according to the preferred embodiment of the invention.

### DETAILED DESCRIPTION

In the Figures of the drawings the same reference numerals refer to the same elements, parts or components or to elements, parts or components with the same function, unless otherwise stated.

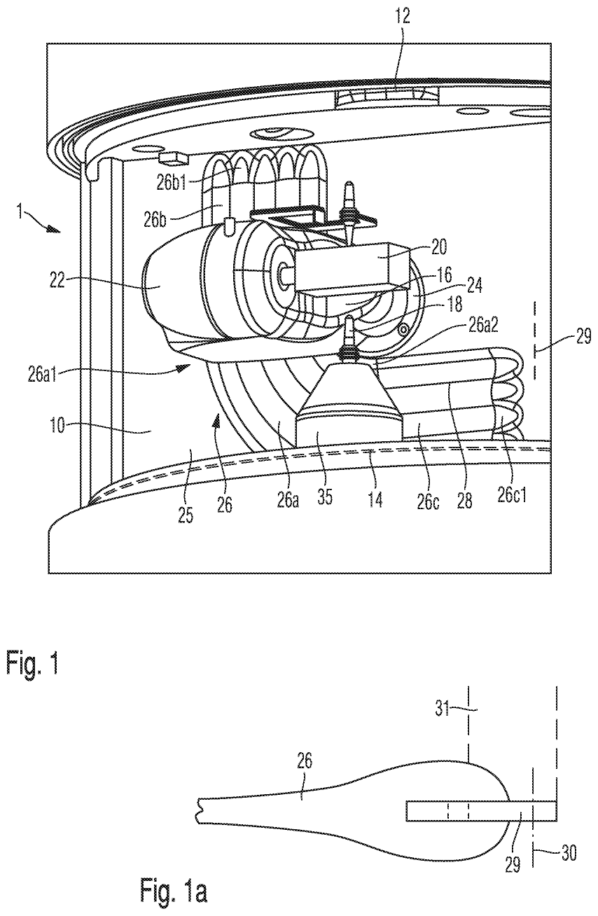

FIG. 1 shows a schematic illustration of a dental machining unit according to a preferred embodiment of the invention.

The dental machining unit 1 comprises a milling chamber 10. The milling chamber 10 comprises a sealed door 12 which is sealed with respect to the environment 13 of the dental machining unit 1 against leakage of liquid. The milling chamber 10 comprises a liquid feed line 14. The liquid feed line 14 ends preferably in one nozzle or several nozzles. The milling chamber 10 further comprises a liquid outlet (not illustrated in FIG. 1). By means of the liquid feed line 14 a liquid is fed to a work region 16 of the dental machining unit 1 in which a milling tool 18 machines a workpiece 20.

The workpiece 20 is mounted to a workpiece arm 22 movably in at least two spatial directions. The workpiece arm 22 passes through a movement flange 24 at which the workpiece arm 22 passes through a passage wall 25 of the milling chamber 10. The passage wall 25 comprises a membrane 26 which allows for movement of the workpiece arm 22 in at least two spatial directions and consists of a highly elastic material. Further, the membrane 26 comprises corrugations 28. The corrugations 28 extend substantially transversely to an axial direction of the membrane 16.

For instance, the membrane is made of elastomeric polyurethane, particularly preferably of the material silicone with a shore hardness of 10 or even 15. The aforementioned material comprises good flexibility while having a high tensile strength at the same time. Its elasticity should amount to more than 200%, and its hardness should amount to between 10 Shore and 20 Shore.

Preferably, the membrane 26 is configured in the shape of a partial circle sectionally. Preferably, the membrane 26 comprises a first portion 26a configured in the shape of a partial circle, a second portion 26b which is configured substantially linearly and which is adjacent to a first axial end portion 26a1 of the first portion 26a of the membrane 26 configured in the shape of a partial circle, and a third portion 26c which is configured substantially linearly and which is adjacent to a second axial end portion 26a2 of the first portion 26a of the membrane 26 configured in the shape of a partial circle.

An axial end portion 26c1 of the third portion 26c which is configured substantially linearly and an axial end portion 26b1 of the second portion 26b which is configured substantially linearly, which form respective axial end portions of the membrane 26, are rounded each, wherein every corrugation 28 comprises a rounded end portion.

The corrugations 28 are preferably configured as concentric circles in certain areas which substantially form sinusoidal curves when viewed in the cross section. Alternatively to providing corrugations in the form of concentric circles, the corrugations may, for instance, be configured in the form of partially concentric circles.

Preferably, at least two and at most 20 corrugations 28 of the membrane 26 are provided. The corrugations preferably extend radially towards the outside when viewed from the direction of the movement flange 24. Furthermore, the membrane 26 is configured in a passage wall 25 of the milling chamber 10 and is provided with a connection flange 29 which is configured to be circumferential. The membrane 26 is held clamped in a sealed manner by the connection flange 29.

In this respect, a possible realization is apparent from FIG. 1a. The connection flange 29 is injection-molded into the membrane 26. The membrane is thicker at the edge side and becomes thinner the larger the distance to the connection flange is, up to a predefined minimum thickness.

The connection flange 29 is attached to an adjacent housing wall 31 by means of a fastening element, preferably a screw connection 30. Said housing wall is preferably in contact with the membrane 26 to enable sealing in this respect.

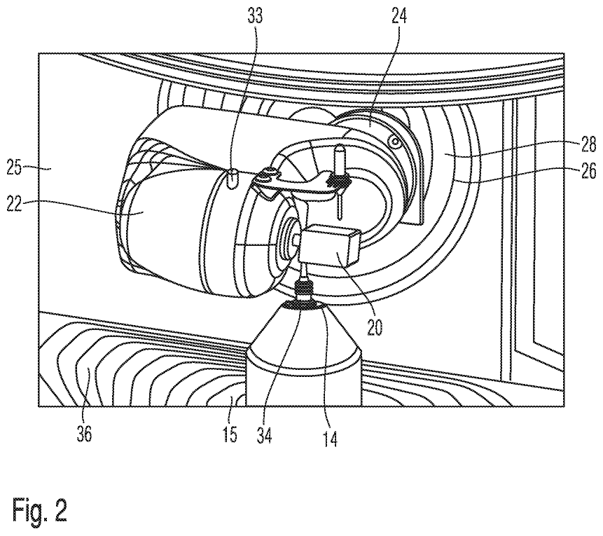

FIG. 2 shows a further schematic illustration of the dental machining unit according to the preferred embodiment of the invention.

The liquid feed line 14 is preferably configured as a nozzle. The nozzle is arranged parallel to the extension of the membrane 26 in the outflow direction.

The nozzles are preferably formed by a nozzle flap which is directed towards the inside, that is to say in the direction of the machining tool, at an angle of substantially 10 to 30°, preferably 20°. A nozzle stream impinges on the milling or machining tool and slides further to the front to the machining surface.

The liquid outlet 15 is preferably arranged at a bottom wall 36 of the milling chamber 10, particularly preferably at a deepest point of the milling chamber 10 in order to promote flow-off of the liquid.

The liquid feed line 14 preferably comprises several nozzles, whose outflow directions are substantially parallel. Thus, the liquid is fed to the machining area and thereat impinges on the milling tool 18 and/or the workpiece 20 before the liquid can reach the membrane 26. Preferably, the liquid feed line 14 is integrated into a chuck 34 of the milling tool 18.

A driver 33 which is configured at the workpiece arm 22 for carrying along the door 12 to open and close it is illustrated in FIG. 2 at the top.

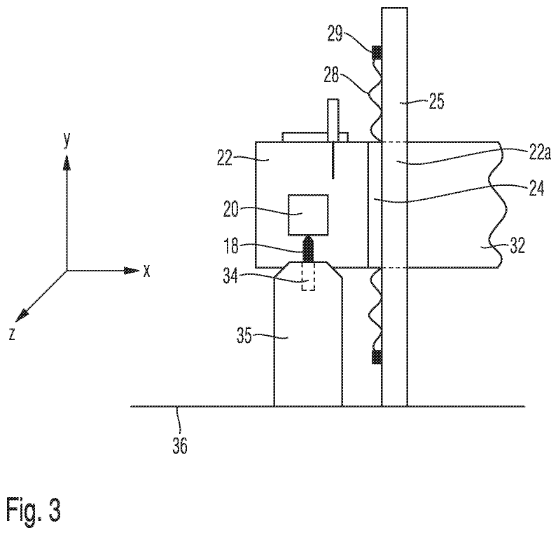

FIG. 3 shows a cross-sectional view of a milling chamber of the dental machining unit according to the preferred embodiment of the invention.

The movement flange 24 of the workpiece arm 22 is preferably configured at a rigid partial arm 22a of the workpiece arm 22 which passes through the membrane 26. The partial arm 22a of the workpiece arm 22 can have any suitable shape.

Beyond the passage wall 25, that is to say outside of the milling chamber 10, the workpiece arm 22 comprises movement elements 32 which extend in three spatial directions. The design of the movement elements 32 is not illustrated in detail. The movement elements 32 extend corresponding to the axes X, Y, Z and two rotational axes for rotating a tool chuck 34 or a collet for the workpiece 20.

In the milling chamber 10 a milling spindle 35 is provided which is arranged fixed in place. The milling spindle 35 carries a tool chuck 34. The tool chuck 34 carries a milling tool 18. Preferably, the milling spindle 35 is attached to the bottom wall 36 of the milling chamber 10. Alternatively, it is also possible to attach the milling spindle to another suitable wall of the milling chamber 10.

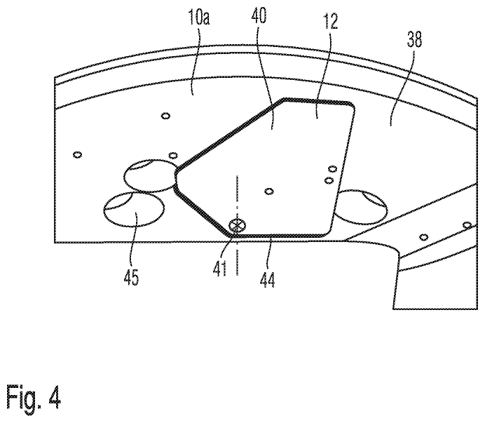

FIG. 4 shows an enlarged illustration of a ceiling wall of the milling chamber of the dental machining unit when the door is closed according to the preferred embodiment of the invention.

The sealed door 12 of the dental machining unit 1 is preferably arranged at a wall surface 10a of the milling chamber 10, preferably at a ceiling wall 38 of the milling chamber 10.

Preferably, the sealed door comprises a plate-shaped element 40 which is arranged at the ceiling wall 38 of the milling chamber 10. The plate-shaped element 40 covers an opening 42 configured in the wall surface 10a of the milling chamber 10, preferably in the ceiling wall 38 of the milling chamber 10, when the door 12 is closed. Alternatively, the door may be configured, for instance, to be accommodated in the opening (not illustrated in FIG. 4) in a flush manner.

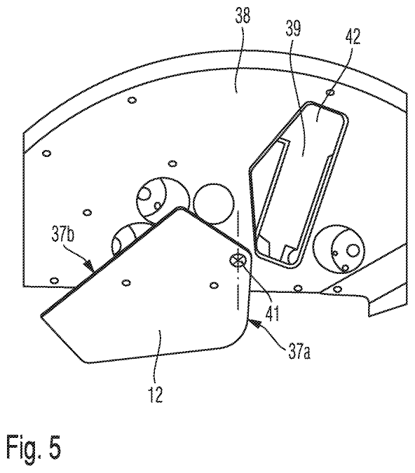

FIG. 5 shows an enlarged illustration of the ceiling wall of the milling chamber of the dental machining unit when the door is open according to the preferred embodiment of the invention.

The sealed door 12 is preferably configured such that by means of a workpiece and/or tool magazine 39 which is arranged beyond the wall surface 10a of the milling chamber 10, that is to say outside of the milling chamber 10, a change of the milling tool (not shown in FIG. 5) may be performed when the door 12 is open. In FIG. 5, the door 12 is shown in its open state. Preferably, the door 12 may be controlled such that the door 12 is opened as the driver 33 of the workpiece arm carries it along, and closed after the change of the milling tool (not shown in FIG. 5) has been performed. For this purpose, the driver 33 preferably slides the door 12 at a suitable driver edge 37a and 37b into the open and closed positions (FIG. 5 and FIG. 4).

Instead, a recess may also be provided which is engaged by the pin-shaped driver 33 for actuating the door 12.

Then, the movement is performed in the manner of a circular arc as the door is mounted pivotably around a pivot axis 41.

Although the present invention has been described above on the basis of preferred exemplary embodiments, it is not limited hereto, but may be modified in a variety of ways. In particular, the invention may be changed or modified in various ways, without deviating from the scope of the invention.

For instance, a shape, dimension or quality of the components of the dental machining unit may be changed.

1. A dental machining unit comprising
a milling chamber which comprises at least one sealed door (12) and which is sealed with respect to the environment against leakage of liquid,
wherein the milling chamber comprises a liquid feed line and a liquid outlet (15), and
wherein via the liquid feed line, a liquid may be fed to a work region of the dental machining unit in which a milling tool machines a workpiece, and
wherein the workpiece is movably mounted to a workpiece arm in at least two spatial directions,
wherein the workpiece arm passes through a movement flange at which the workpiece arm passes through a passage wall of the milling chamber which extends, and
whereinin that the passage wall comprises a membrane which allows for movement of the workpiece arm in at least two spatial directions and is fabricated of a highly elastic material and forms at least partially a wall of the milling chamber.

2. The dental machining unit as claimed in claim 1,
wherein corrugations of the membrane are configured as concentric circles or as concentric partial circles which substantially form sinusoidal curves when viewed in a cross sectional view.

3. The dental machining unit as claimed in claim 1, wherein at least two and at most twenty corrugations of the membrane extend radially towards the outside when viewed from a direction of the movement flange.

4. The dental machining unit as claimed in claim 1, wherein the membrane is held clamped in a sealed manner at the passage wall of the milling chamber which extends two-dimensionally by a connection flange which is configured to be circumferential.

5. The dental machining unit as claimed in claim 1, wherein the connection flange is formed of a rigid material and is attached to walls of the milling chamber other than the passage wall.

6. The dental machining unit as claimed in claim 1, wherein the movement flange of the workpiece arm is configured at a rigid partial arm of the workpiece arm which passes through the membrane.,

7. The dental machining unit as claimed in claim 1, wherein, beyond the passage wall and outside of the milling chamber, the workpiece arm comprises movement elements in three spatial directions corresponding to the axes X, Y, Z and two rotational axes for rotating a tool chuck or a collet for the workpiece (20), together with the workpiece clamped therein.

8. The dental machining unit as claimed in claim 1, wherein a milling spindle is provided in the milling chamber, wherein said milling spindle is arranged fixed in place and carries a tool chuck which carries the milling tool in a clamped manner,
wherein said milling spindle is attached to the bottom wall of the milling chamber.

9. The dental machining unit as claimed in claim 1,any of the preceding wherein the liquid feed line comprises at least one nozzle, which is arranged inclined to an extension of the membrane in the outflow direction.

10. The dental machining unit as claimed in claim 1, wherein the liquid feed line comprises several nozzles having outflow directions substantially parallel to one another and converge, and
wherein the liquid is fed to the machining area and thereat impinges on the milling tool and/or the workpiece during the machining process, before liquid can reach the membrane (26).

11. The dental machining unit as claimed in claim 1, wherein a milling spindle is provided which carries a chuck for the milling tool (18), and
wherein a nozzle plate connected with the dental machining unit carries at least one nozzle for the liquid feed line into the milling chamber, said nozzle rotating with the chuck.

12. The dental machining unit as claimed in claim 11,
wherein several nozzles are arranged at the chuck such that the several nozzles are evenly distributed around the milling tool, the several nozzles having outflow directions extending substantially parallel to the milling tool or towards a tip of the milling tool.

13. The dental machining unit as claimed in claim 1,
wherein the workpiece arm comprises a driver (33) which may be used to actuate the door.

14. The dental machining unit as claimed in claim 1,
wherein the sealed door is arranged at a wall surface of the milling chamber,
wherein the sealed door is configured such that by means of a workpiece and/or tool magazine which is arranged beyond the wall surface of the milling chamber, and outside of the milling chamber, a change of the milling tool (18) may be performed when the door (12) is open.

15. The dental machining unit as claimed in claim 13,
wherein the sealed door comprises a plate-shaped element which is arranged at the wall surface of the milling chamber,
wherein the plate-shaped element covers an opening configured in the wall surface of the milling chamber when the door is closed,
wherein the opening and/or the door comprises at least one sealing element.

16. The dental machining unit as claimed in claims 13,
wherein the door may be controlled such that the door may be opened upon actuation of the tool changer and/or the workpiece changer, and may be closed after the change of the milling tool has been carried out.

17. The dental machining unit as claimed in claim 1,
wherein the membrane is configured at least sectionally in the shape of a partial circle, wherein the membrane comprises a first portion configured in the shape of a partial circle, a second portion which is configured substantially linearly and which is adjacent to a first axial end portion of the first portion of the membrane configured in the shape of a partial circle, and a third portion which is configured substantially linearly and which is adjacent to a second axial end portion of the first portion of the membrane configured in the shape of a partial circle.

18. The dental machining unit as claimed in claim 1
wherein the liquid feed line comprises a nozzle,
wherein the passage wall of the milling chamber (10) extends two-dimensionally or flatly, and
wherein the membrane forms the rear wall or the entire passage wall of the milling chamber.

19. The dental machining unit as claimed in claim 5,
wherein rigid material comprises metal or rigid plastic material and
wherein the connection flange is embedded into the membrane and/or connected therewith closely.

20. The dental machining unit as claimed in claim 14,
wherein the sealed door is arranged at a ceiling wall of the milling chamber.

21. The dental machining unit as claimed in claim 15,
wherein the plate-shaped element is arranged at the ceiling wall of the milling chamber,
wherein the plate-shaped element covers an opening configured in the ceiling wall of the milling chamber, when the door is closed, wherein the opening and/or the door comprises at least one sealing element.

22. The dental machining unit as claimed in claim 16,
wherein the door may be opened upon actuation of the workpiece arm.
